(19) United States
(12) Patent Application Publication
(10) Pub. No.: US 2026/0340458 A1
(43) Pub. Date: Oct. 29, 2026

(54) Dual-Hemisphere Cognitive Control Architecture for Governed AI Reasoning

(71) Applicant: Marc Lane, Indianapolis, IN (US)

(72) Inventor: Marc Lane, Indianapolis, IN (US)

(21) Appl. No.: 19/362,621

(22) Filed: Oct. 20, 2025

(51) Int. Cl. G06N 5/045; G06N 5/025

(52) U.S. Cl. CPC G06N 5/045; G06N 5/025

(57) ABSTRACT

A cognitive orchestration system for governed artificial intelligence reasoning is disclosed. The architecture includes analytical and generative controllers linked by a telemetry bus and governed by a compliance cortex. The analytical controller decomposes tasks, enforces constraints, and verifies outputs, while the generative controller creates candidate solutions. The telemetry bus exchanges feedback for iterative refinement. The compliance cortex monitors reasoning, applies policy rules, and records decision lineage. Together these components form a closed-loop cycle joining creative generation with logical validation under governance. The system provides adaptive, transparent reasoning for multi-agent orchestration, enterprise automation, and autonomous decision systems requiring explainable and reliable behavior across computing environments.

### CROSS-REFERENCE TO RELATED U.S. APPLICATIONS

This application is the first filed application directed to the Dual-Hemisphere Cognitive Control Architecture for Governed Artificial-Intelligence Reasoning. A related application entitled “Schema-Driven AI Agent Generation and Lifecycle Governance” is expected to be filed subsequently and may reference this application as a related disclosure. No priority claim is made to any prior-filed U.S. or foreign application.

### STATEMENT REGARDING FEDERALLY SPONSORED RESEARCH OR DEVELOPMENT

No federally sponsored research or development was involved in the conception or reduction to practice of the present invention.

### REFERENCE TO A “SEQUENCE LISTING,” TABLE, OR COMPUTER PROGRAM APPENDIX

Not applicable.

### BACKGROUND OF THE INVENTION

### Field of the Invention

The present invention relates generally to artificial intelligence (AI) systems and frameworks designed to enhance the reliability, transparency, and governance of machine reasoning. It addresses how intelligent systems can perform complex reasoning and decision-making tasks while remaining explainable and compliant with organizational or regulatory policies.

More particularly, the invention pertains to cognitive orchestration architectures that coordinate multiple reasoning modules or agents under embedded governance and compliance control. Such architectures enable modular AI components to operate cooperatively while adhering to defined behavioral constraints, accountability rules, and auditable decision processes.

The invention further provides mechanisms for synchronizing analytical and generative reasoning processes through structured feedback exchange. This synchronization allows data-driven analysis and creative synthesis to interact dynamically, improving accuracy, adaptability, and contextual awareness across diverse computing environments.

Specifically, the invention concerns a dual-hemisphere cognitive control architecture that integrates analytical reasoning and generative synthesis through a telemetry-based feedback loop governed by a compliance layer. The architecture supports explainable AI operations, controlled innovation cycles, and verifiable reasoning outcomes suitable for enterprise automation, multi-agent coordination, and autonomous decision systems.

### Description of Related Art

Recent advances in artificial intelligence (AI) have produced a variety of orchestration frameworks and cognitive architectures that coordinate multiple models or agents to complete complex reasoning tasks. Examples of such frameworks include systems designed for large language model (LLM) chaining, multi-agent coordination, or cognitive task decomposition.

These systems illustrate the growing focus on modular reasoning and tool integration but generally rely on linear or static workflows and lack persistent feedback control or integrated governance mechanisms.

Earlier cognitive architectures introduced symbolic reasoning methods but predate modern generative AI capabilities and do not provide dynamic compliance or telemetry synchronization between reasoning components. Contemporary alignment techniques apply written ethical principles to guide model behavior but typically operate within single-pass or single-agent environments without persistent audit logging or cross-agent validation.

Consequently, many existing AI reasoning frameworks emphasize flexibility and creativity but depend on external or after-the-fact validation mechanisms. The present invention introduces a new cognitive control paradigm that embeds verification, telemetry synchronization, and policy compliance directly within the reasoning process itself.

### SUMMARY OF THE INVENTION

The present invention provides a cognitive orchestration architecture for governed artificial-intelligence reasoning, referred to as a Dual-Hemisphere Cognitive Control Architecture. The architecture introduces a neuro-inspired control model that divides reasoning into two coordinated hemispheres—an Analytical Controller and a Generative Controller—linked by a bi-directional telemetry interface and overseen by a Compliance Cortex.

In one embodiment, the Analytical Controller performs structured reasoning, task decomposition, and constraint enforcement. It verifies factual accuracy and logical consistency of proposed solutions, applying deterministic or rule-based evaluation methods. In another embodiment, the Generative Controller produces candidate solutions or hypotheses using generative-AI models, large language models, or other machine-learning components configured for creative synthesis.

A Telemetry Bus communicatively couples the Analytical and Generative Controllers. The telemetry bus transmits intermediate reasoning data, confidence scores, constraint signals, and feedback instructions, enabling iterative refinement and synchronization between hemispheres. This continuous feedback loop allows the analytical process to critique and improve generative outputs in real time.

Overlaying both controllers is a Compliance Cortex, a governance layer configured to enforce policy rules, regulatory constraints, and ethical guidelines. The Compliance Cortex monitors all communications over the telemetry bus, evaluates outputs for compliance, and logs decision lineage in an Adaptive Memory Layer to provide transparency and auditability. Upon detection of a rule violation, the Compliance Cortex may halt or modify processing, inject corrective signals, or trigger re-evaluation by the Analytical Controller.

The architecture operates in a closed-loop reasoning cycle comprising (1) task decomposition, (2) candidate generation, (3) telemetry exchange, (4) analytical verification, (5) compliance validation, and (6) result dispatch. The cycle repeats until a candidate satisfies both logical and policy constraints. The system may output not only the final result but also an explanation report detailing reasoning steps and compliance actions.

In various embodiments, the invention may be implemented using separate or partitioned AI models, structured telemetry schemas, or modular software processes deployed on local or cloud computing environments. The system may further extend to multi-agent ensembles wherein multiple generative or analytical agents operate under the same dual-hemisphere control paradigm.

By integrating dual-channel reasoning, real-time feedback, and embedded governance, the present invention provides a governed-autonomy framework that ensures reliability, compliance, and explainability across AI applications including enterprise automation, legal analysis, healthcare decision support, robotics, and autonomous planning systems.

### BRIEF DESCRIPTION OF THE DRAWINGS

FIG. 1 is a block diagram illustrating an exemplary architecture of the Dual-Hemisphere Cognitive Control System. The diagram depicts an Analytical Controller and a Generative Controller (left and right hemispheres) connected by a Telemetry Bus, with a Compliance Cortex overlaying both controllers. The figure also shows optional elements such as a Policy Store, Audit Log, and external data or tool interfaces.

FIG. 2 is a flowchart illustrating an exemplary reasoning cycle of the Dual-Hemisphere Cognitive Control Architecture. The flowchart includes sequential steps such as receiving a task, analytical decomposition, generative candidate creation, telemetry exchange, analytical verification, compliance validation and logging, and result dispatch. Iterative feedback loops between the Analytical and Generative Controllers are shown to represent the closed-loop reasoning process.

FIG. 3 is a schematic representation of a computing environment suitable for implementing embodiments of the invention. The diagram includes one or more processors, system memory, and networked components hosting the Analytical Controller, Generative Controller, Telemetry Bus, and Compliance Cortex. It also illustrates input and output interfaces, a policy database, and a secure audit-log repository.

FIG. 4 is a block diagram illustrating an exemplary Telemetry Object Schema employed for structured communication between the Analytical Controller and the Generative Controller. The diagram shows a central telemetry object containing labeled fields—Confidence Value, Reasoning Class Identifier, Constraint Code, and Provenance Hash—with bi-directional arrows to the Analytical Controller and Generative Controller and a monitoring link to the Compliance Cortex to indicate governed data exchange.

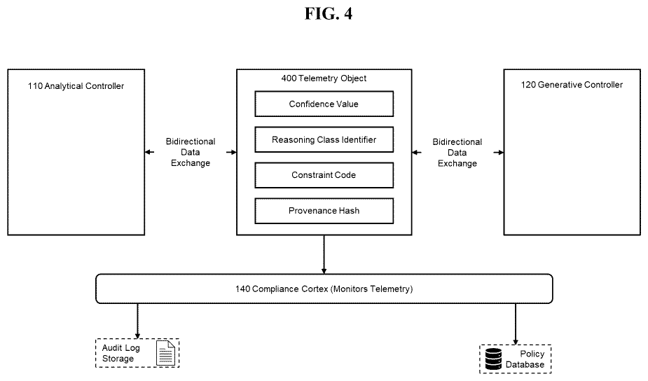

FIG. 5 is a schematic Policy-Gate Sequence Diagram showing the four principal governance checkpoints of the reasoning cycle: Pre-Compose, Pre-Execute, In-Loop, and Pre-Emit. The diagram depicts the flow of information through these gates along the closed reasoning loop, with each gate linked to corresponding enforcement or validation actions managed by the Compliance Cortex.

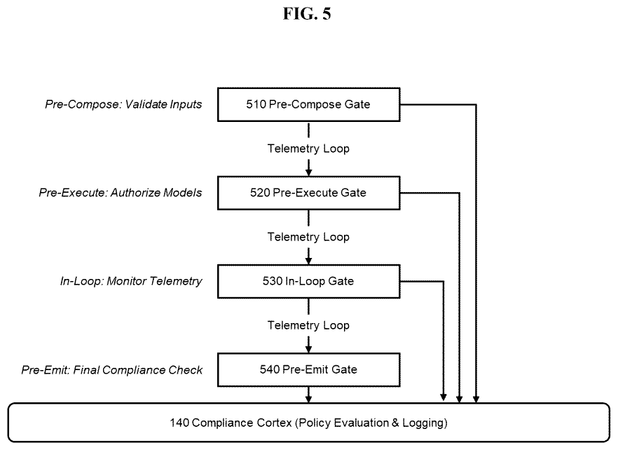

### DETAILED DESCRIPTION OF THE INVENTION

The following description illustrates embodiments of a Dual-Hemisphere Cognitive Control Architecture (hereinafter “MCP”) for governed artificial-intelligence reasoning. The embodiments described are exemplary only and are not intended to limit the scope of the invention. Elements or steps described with respect to one embodiment may be combined with or substituted for those of another embodiment as would be apparent to a person skilled in the art.

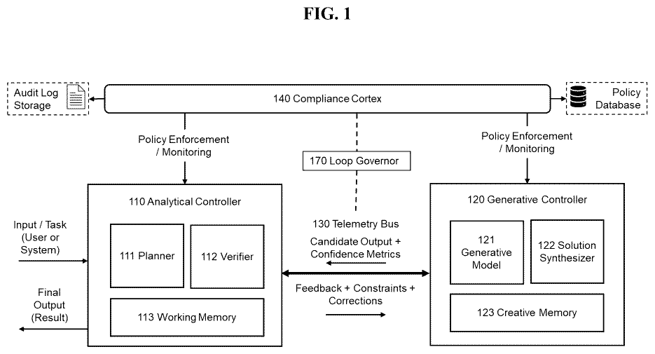

### System Overview (FIG. 1)

Referring to FIG. 1, the MCP architecture 100 comprises an Analytical Controller 110, a Generative Controller 120, a Telemetry Bus 130 interconnecting the controllers, and a Compliance Cortex 140 overseeing the process. Each controller may be implemented in software, firmware, or hardware and may execute on a shared or distributed computing substrate.

The Analytical Controller 110 performs structured reasoning, task decomposition, and constraint enforcement. In certain embodiments it includes a Planner Module 111 for dividing complex tasks into sub-tasks and a Verifier Module 112 for evaluating candidate outputs. The Analytical Controller may maintain a Working Memory 113 that stores intermediate facts, goals, and accepted partial solutions. Verification may involve rule-based checks, algorithmic computation, or invocation of external tools such as databases or simulation engines.

The Generative Controller 120 performs creative synthesis and hypothesis generation. It may include a Generative Model 121 (for example, a large-language or diffusion model) and a Synthesis Module 122 that organizes outputs according to the Analytical Controller's plan. The Generative Controller may maintain a Creativity Context 123 to record alternate drafts, confidence values, or reasoning traces. Outputs may include accompanying metadata such as self-assessed confidence or rationale indicators.

The Telemetry Bus 130 provides bi-directional communication between the hemispheres. It transmits intermediate reasoning data, feedback instructions, confidence metrics, and constraint signals. In one embodiment the telemetry bus is a shared memory or structured message queue; in another embodiment it is a publish-subscribe network interface. Control signals such as proceed, halt, revise, and approve may be exchanged continuously during operation, thereby synchronizing the controllers.

In one embodiment, telemetry data are encapsulated in typed telemetry objects comprising at least a confidence value, a reasoning-class identifier, a constraint or error code, and a provenance hash linking the object to a specific reasoning step. The schema may be expressed in JSON, XML, or equivalent typed formats, ensuring deterministic interchange between controllers.

The Compliance Cortex 140 overlays the dual controllers and enforces policy and governance constraints. It accesses a Policy Store 150 containing predefined rules, ethical guidelines, and regulatory parameters. The Compliance Cortex performs two principal functions: (a) enforcement, by detecting and preventing policy violations during reasoning; and (b) logging, by writing detailed entries to an Audit Log 160 describing decisions, applied rules, and corrective actions. Enforcement may include modifying, masking, or halting outputs that conflict with stored policies.

The Compliance Cortex exposes a governance-evaluation API receiving telemetry objects as input and returning governance directives selected from {continue, revise, halt}. Each transaction is logged with a cryptographic hash, forming an immutable audit chain.

The Compliance Cortex maintains an evidentiary telemetry ledger that hash-chains all telemetry events and policy decisions. The ledger enables verifiable replay of reasoning cycles and prevents post-hoc alteration of compliance records.

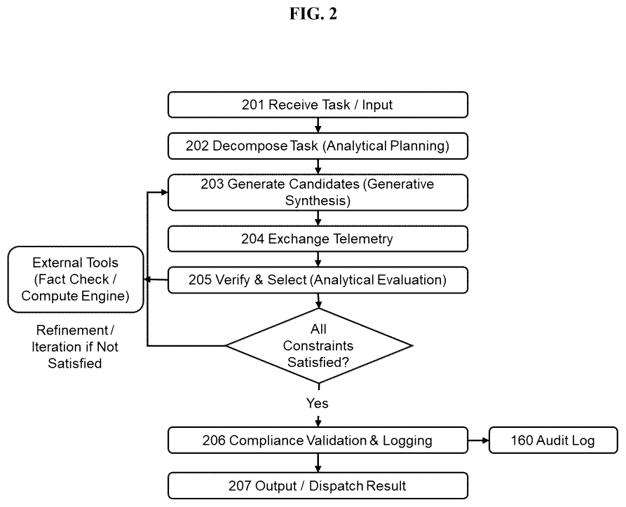

### Reasoning Cycle (FIG. 2)

As shown in FIG. 2, operation of the MCP follows an iterative, closed-loop reasoning cycle 200. Each cycle comprises the following stages:
(a) Task Reception (201): The MCP receives a task, query, or goal description through an input interface. The Analytical Controller parses the request to identify objectives and constraints.
(b) Analytical Decomposition (202): The Analytical Controller generates a structured plan or set of sub-tasks. It may consult the Compliance Cortex to load relevant policies into working memory.
(c) Generative Synthesis (203): The Generative Controller produces one or more candidate solutions using the guidance provided by the Analytical Controller. Each candidate may include accompanying metadata such as confidence scores or reasoning traces.
(d) Telemetry Exchange (204): The Telemetry Bus transmits candidate outputs and associated telemetry from the Generative Controller to the Analytical Controller, and returns evaluation cues in the opposite direction. Synchronization may occur continuously or in discrete iterations.
(e) Analytical Verification (205): The Analytical Controller evaluates each candidate against logical and factual criteria. External verification engines or data sources may be invoked as needed. If discrepancies or violations are detected, the Analytical Controller prepares feedback describing necessary corrections.
(f) Compliance Validation and Logging (206): The Compliance Cortex monitors each iteration, compares outputs with stored policy rules, and records results. Upon detecting a violation, the Compliance Cortex issues a corrective signal through the Telemetry Bus, prompting regeneration or modification by the Generative Controller.
(g) Result Dispatch (207): When a candidate satisfies analytical and compliance criteria, the system outputs the approved result through an output interface. The Audit Log records the final reasoning path and the rationale for acceptance.

Loop Governor (Termination Control) (170): In certain embodiments, a Loop Governor is provided to monitor iteration depth, elapsed time, or convergence thresholds within the closed-loop reasoning cycle. The Loop Governor detects non-convergent or infinite recursion conditions by evaluating telemetry signals, feedback frequency, or stability metrics exchanged between the Analytical Controller and the Generative Controller. Upon determining that the reasoning process is oscillating or exceeding defined thresholds, the Loop Governor halts or resets the reasoning cycle and may initiate a compliance or error-handling procedure. The Loop Governor may operate under supervision of the Compliance Cortex or as an independent watchdog process coupled to the Telemetry Bus.

In some embodiments the Loop Governor adjusts permitted iteration depth or confidence thresholds dynamically according to statistical summaries of prior telemetry cycles, enabling adaptive termination control responsive to reasoning stability metrics.

Governance policies may apply at four distinct policy-gate stages: (1) pre-compose, validating input tasks and constraints; (2) pre-execute, screening candidate generation requests; (3) in-loop, inspecting iterative telemetry exchanges; and (4) pre-emit, validating final results. Each gate operates under distinct policy subsets and enforcement actions.

The reasoning cycle may repeat until a termination condition is met, such as successful validation, exhaustion of iterations, or a human-review trigger. The closed-loop design, augmented by the Loop Governor, ensures that no generative output is finalized without analytical verification, policy compliance, and controlled termination.

### Algorithmic Processes

### Analytical Controller Algorithm.

1. Receive an input task T from a user, external process, or higher-level controller.
2. Decompose Tinto sub-tasks {t₁, t₂, . . . , tₙ} using a planning heuristic Ha based on task structure and constraints.
3. For each sub-task tᵢ:
   (a) Define evaluation metrics Eᵢ including accuracy, confidence, or compliance parameters.
   (b) Store intermediate data in Working Memory 113.
4. Transmit the structured plan P={tᵢ, Eᵢ, constraints} to Generative Controller 120 via the Telemetry Bus 130.

### Generative Controller Algorithm.

1. Receive structured plan P from Analytical Controller 110.
2. For each tᵢ in P:
   (a) Generate a candidate solution set Sᵢ={s₁, s₂, . . . , sₘ} using a generative model 121.
   (b) Assign each sⱼ a confidence score C(sⱼ) and reasoning trace R(sⱼ).
3. Transmit {Sᵢ, C, R} through Telemetry Bus 130 for verification.

### Telemetry Exchange Algorithm.

1. Relay candidate data from Generative Controller 120 to Analytical Controller 110.
2. Receive verification and corrective feedback F={accept, reject, revise, halt} from Analytical Controller 110.
3. Forward any compliance events or policy alerts from Compliance Cortex 140 to both hemispheres.
4. Log all telemetry transactions with timestamps and feedback metadata.

### Compliance Cortex Algorithm.

1. For each reasoning iteration, retrieve applicable rules R from Policy Store 150.
2. Evaluate outputs or telemetry events against R:
   (a) If violation_detected(r)=TRUE, execute r.action∈{modify, block, alert}.
   (b) Otherwise, mark event as compliant.
3. Log {rule_ID, decision_state, timestamp} to Audit Log 160 and issue compliance feedback to Analytical Controller 110.

### Loop Governor Algorithm.

1. Initialize control counters: iteration_count=0, stability_score=0.
2. While the reasoning cycle 200 is active:
   (a) Monitor telemetry frequency, confidence variance, and feedback density.
   (b) If non-convergence detected (|Δconfidence|>ε for N iterations), set system state=HALT and send stop signals to both hemispheres.
   (c) Record halt condition in Audit Log 160.
3. Upon stabilization or manual intervention, reset counters and resume reasoning loop.

The foregoing algorithmic processes collectively implement the iterative reasoning cycle of FIG. 2. Each controller operates according to the defined computational steps to ensure deterministic coordination, policy enforcement, and convergence stability under governance control. These algorithms may be expressed in any equivalent programming language or execution environment capable of performing the described logic.

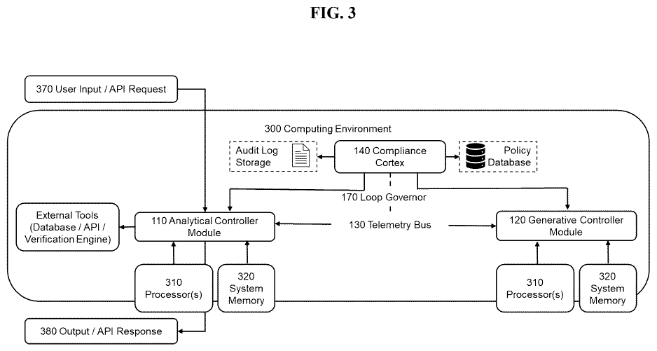

### Computing Environment (FIG. 3)

Referring to FIG. 3, embodiments may be implemented on a computing system 300 comprising one or more processors 310, memory 320, storage 330, and network interfaces. The Analytical Controller 110, Generative Controller 120, Telemetry Bus 130, Compliance Cortex 140, and Loop Governor 170 may execute as separate processes or services on the same or different machines. A Policy Database 350 and Audit Repository 360 provide persistent governance data and trace logs. Input interfaces 370 and output interfaces 380 enable integration with user applications or autonomous subsystems.

The algorithmic procedures defined in paragraphs [0034A]-[0034E] may be implemented in software modules, microservices, or dedicated hardware controllers. Each procedure executes under control of the processor(s) 310, using instructions stored in memory 320, and may communicate over network interfaces or internal buses to coordinate analytical reasoning, generative synthesis, and compliance enforcement. Equivalent execution environments are contemplated, including virtualized, cloud-native, or embedded deployments.

### ALTERNATIVE AND EXTENDED EMBODIMENTS

In some embodiments, the dual hemispheres are implemented as two specialized large-language models operating concurrently and asynchronously. In other embodiments, both hemispheres are realized within a single composite model partitioned into two cooperating sub-models that exchange intermediate states through an internal memory queue.

The architecture may be extended to multi-agent ensembles wherein additional generative or analytical agents are dynamically instantiated under coordination of a master Analytical Controller. The same telemetry and compliance mechanisms apply, thereby scaling the dual-hemisphere paradigm to distributed reasoning networks.

The Compliance Cortex may incorporate a machine-learning classifier trained to detect undesirable or misaligned outputs, including toxic, biased, or non-compliant language. When such content is detected, the classifier issues a reformulation instruction to the Generative Controller via the Analytical Controller.

In certain embodiments, the Analytical Controller maintains a session log of all feedback transmitted to the Generative Controller. This log serves as contextual memory, allowing subsequent iterations to reference prior critiques and avoid repeating errors. The system thus develops adaptive coherence across reasoning sessions.

Alternative configurations may include multi-objective evaluators that balance competing criteria such as accuracy, cost, or computational efficiency. Weighted feedback signals transmitted over the telemetry bus guide the Generative Controller toward optimal trade-offs among objectives.

The architecture is applicable to diverse domains, including enterprise decision support, healthcare analytics, robotics, financial modeling, and creative content generation. In each case the system provides governed autonomy—autonomous reasoning constrained by verifiable compliance and explainable outputs.

The algorithmic processes disclosed herein are illustrative of machine-executable logic used by the respective controllers. Alternative implementations employing different control flows, computational heuristics, or data structures that perform substantially the same governed reasoning, telemetry synchronization, and compliance validation functions are considered within the scope of the invention.

The embodiments described herein collectively demonstrate a unified cognitive-control system that combines the flexibility of generative AI with the rigor of analytical validation and continuous governance. Modifications and variations of the disclosed embodiments may be made without departing from the spirit or scope of the invention, which is defined by the appended claims.

### CONCLUSION

While various embodiments of the invention have been described, it will be understood that numerous variations, substitutions, and equivalents may be employed without departing from the scope of the appended claims. The scope of protection sought is defined solely by the claims that follow, interpreted in accordance with the applicable statutes and regulations of the United States Patent and Trademark Office.

What is claimed is:

1. A cognitive reasoning system for orchestrating multiple artificial-intelligence agents under governance constraints, comprising:
(a) an analytical reasoning module configured to receive a problem definition and apply one or more logical rules or constraints to candidate solutions of the problem;
(b) a generative reasoning module configured to generate one or more candidate solutions for the problem using a generative artificial-intelligence model;
(c) a bidirectional telemetry interface communicatively coupling the analytical reasoning module and the generative reasoning module, the telemetry interface being configured to transmit intermediate data and feedback signals between the modules; and,
(d) a compliance module operatively connected to the analytical reasoning module and the generative reasoning module, the compliance module having access to one or more predefined policy rules and being configured to monitor outputs of the reasoning modules and to enforce the policy rules by intervention or flagging when a candidate solution or portion thereof violates a policy rule;
wherein the analytical reasoning module and the generative reasoning module operate in a closed-loop manner such that the generative reasoning module produces candidate solutions, the analytical reasoning module evaluates the candidate solutions and returns feedback, and the compliance module validates conformance with the policy rules before any final output is released.

2. The system of claim 1, wherein the analytical reasoning module comprises a planner component configured to decompose the problem into sub-tasks and a verifier component configured to check factual accuracy and logical consistency of the candidate solutions.

3. The system of claim 1, wherein the telemetry interface transmits, from the generative reasoning module to the analytical reasoning module, data comprising confidence scores, reasoning traces, and intermediate assumptions, and transmits, from the analytical reasoning module to the generative reasoning module, corrective instructions and approval or disapproval signals.

4. The system of claim 1, wherein the compliance module comprises a policy knowledge base storing rules relating to regulatory requirements, safety constraints, ethical guidelines, or business policies, and a monitoring agent that inspects data passing through the telemetry interface to generate an alert upon detecting a potential violation.

5. The system of claim 4, wherein the compliance module modifies or blocks a candidate solution that violates a rule and logs each intervention and final solution in an audit repository with information identifying which policy rules were applied.

6. The system of claim 1, wherein the generative reasoning module includes a natural-language model and the analytical reasoning module includes a distinct natural-language model fine-tuned for evaluation, and the telemetry interface carries proposals and critiques encoded in a structured format interpretable by both models.

7. The system of claim 1, wherein the analytical reasoning module, during evaluation, invokes one or more external tools selected from a computation engine, a database lookup, or a simulation module to verify aspects of a candidate solution.

8. The system of claim 1, wherein the analytical reasoning module and the generative reasoning module are embodied within a single artificial-intelligence model partitioned into cooperating sub-models that exchange intermediate results through an internal memory queue.

9. The system of claim 1, wherein the cognitive reasoning system dynamically instantiates additional analytical or generative agent processes as needed and coordinates the additional processes using the same telemetry and compliance mechanisms.

10. The system of claim 1, wherein the compliance module includes a machine-learning classifier trained to detect undesirable or misaligned content and, upon detection, instructs the generative reasoning module to reformulate the candidate solution.

11. The system of claim 1, wherein the analytical reasoning module maintains a log of feedback provided to the generative reasoning module, and the generative reasoning module references the log as contextual memory for subsequent iterations.

12. The system of claim 1, wherein the analytical reasoning module performs multi-objective evaluation balancing accuracy, cost, and performance, and transmits weighted feedback to the generative reasoning module to guide optimization.

13. The system of claim 1, wherein the compliance module enforces domain-specific policies including financial, healthcare, or privacy regulations and ensures that final outputs remain compliant with applicable laws.

14. The system of claim 1, implemented in a distributed computing environment in which the analytical reasoning module, the generative reasoning module, and the compliance module execute on separate networked nodes exchanging telemetry and compliance signals in real time.

15. The system of claim 1, further comprising a loop governor configured to monitor iteration count, timing, or convergence of feedback exchanges between the analytical and generative reasoning modules and to interrupt or terminate the reasoning cycle upon detection of a non-convergent or infinite-loop condition.

16. The system of claim 1, wherein the analytical controller, generative controller, telemetry bus, compliance cortex, and loop governor execute the algorithmic processes described in paragraphs [0034A]-[0034E] to perform iterative governed reasoning cycles.

17. The system of claim 1, wherein the compliance cortex algorithm enforces policy rules by detecting violations within telemetry data and issuing corrective feedback through the telemetry bus.

18. The system of claim 1, wherein telemetry data are encapsulated in typed telemetry objects comprising at least a confidence value, a reasoning-class identifier, a constraint code, and a provenance hash.

19. The system of claim 18, wherein the telemetry objects are transmitted via a message-queue or publish-subscribe protocol that preserves asynchronous synchronization between the analytical and generative reasoning modules.

20. The system of claim 1, wherein the compliance module exposes a governance-evaluation API configured to receive telemetry objects, apply stored policy rules, and return governance directives comprising continue, revise, or halt.

21. The system of claim 20, wherein each governance directive and associated telemetry object are recorded in a hash-chained audit ledger to ensure evidentiary integrity.

22. The system of claim 1, wherein a loop governor dynamically adjusts iteration limits or confidence thresholds based on aggregate telemetry statistics from prior reasoning cycles.

23. The system of claim 22, wherein the loop governor identifies convergence or oscillation conditions by evaluating confidence-score variance and feedback frequency over a sliding-window interval.

24. The system of claim 1, wherein governance policies are executed at four policy-gate stages comprising pre-compose, pre-execute, in-loop, and pre-emit gates, each enforcing distinct rule subsets.

25. The system of claim 24, wherein violations detected at an in-loop gate trigger issuance of a typed remediation message specifying which hemisphere must perform corrective action.

26. A computer-implemented method for iterative artificial-intelligence reasoning with integrated governance, comprising:
receiving, by a cognitive controller system, an input defining a task;
decomposing, by an analytical controller process, the task into one or more sub-problems and establishing evaluation criteria;
generating, by a generative controller process, a proposed solution using a generative AI model;
transmitting, via a telemetry interface, the proposed solution and associated metadata from the generative controller process to the analytical controller process;
evaluating, by the analytical controller process, the proposed solution against the evaluation criteria;
monitoring the proposed solution for compliance with one or more policy rules using a compliance process running concurrently with the evaluating step;
transmitting feedback data from the analytical controller process to the generative controller process;
modifying, by the generative controller process, the proposed solution in response to the feedback data;
repeating the generating, evaluating, monitoring, and modifying steps until the analytical controller process determines that the proposed solution satisfies the evaluation criteria and the compliance process confirms policy adherence; and,
outputting the acceptable solution and storing a record of reasoning iterations and policy-enforcement actions in a log repository.

27. The method of claim 26, wherein monitoring for compliance comprises comparing the proposed solution to stored disallowed-content patterns and inserting an alert into the feedback data to trigger removal or alteration of the disallowed content.

28. The method of claim 26, wherein the feedback data includes a request for additional information and the generative controller process retrieves the requested information from an external data source before regenerating a revised solution.

29. The method of claim 26, further comprising generating an explanation report describing revisions performed and rules applied during the reasoning cycle to provide transparency to a user.

30. The method of claim 26, wherein the repeating continues until a termination condition is met selected from the group consisting of: discovery of an acceptable solution, reaching a maximum number of iterations, or determining that no valid solution exists, and wherein upon failure an explanatory notice is output.

31. The method of claim 26, further comprising generating an evidentiary telemetry-ledger entry for each reasoning iteration, the entry comprising a hash of telemetry objects, applied policies, and compliance results.

32. The method of claim 26, further comprising dynamically adjusting an iteration parameter or confidence threshold in response to measured telemetry-stability metrics.

33. A non-transitory computer-readable storage medium storing instructions that, when executed by one or more processors, cause the one or more processors to perform the method of any one of claims 26-32.
